(19) United States
(12) Patent Application Publication
(10) Pub. No.: US 2010/0005909 A1
(43) Pub. Date: Jan. 14, 2010

(54) TORQUE SENSOR WITH REDUCED SUSCEPTIBILITY TO FAILURE

(75) Inventors: Henrik Antoni, Freigericht (DE); Klaus Rink, Rodenbach (DE)

Correspondence Address: RATNERPRESTIA, P.O. BOX 980, VALLEY FORGE, PA, 19482, US

(73) Assignee: Continental Teves AG & Co. oHG, Frankfurt (DE)

(21) Appl. No.: 12/524,662

(22) PCT Filed: Jan. 28, 2008
(86) PCT No.: PCT/EP2008/050920

§ 371 Date: Jul. 27, 2009

(30) Foreign Application Priority Data
Jan. 29, 2007 (DE) 10 2007 005 220.2
Nov. 27, 2007 (DE) 10 2007 057 050.5

(51) Int. Cl. G01L 3/10

(52) U.S. Cl. 73/862.325

(57) ABSTRACT

A sensor arrangement with relatively low disturbance susceptibility for measurement of a torque acting on a shaft, wherein the shaft has a first shaft section and a second shaft section and these two shaft sections can rotate with respect to one another, having at least one magnetic encoder which is arranged on the first shaft section, and having a stator which is arranged on the second shaft section, wherein the stator has two stator elements which each have projecting fingers, wherein at least one additional, second stator, likewise having two stator elements which each have projecting fingers, is arranged on the second shaft section, and these stators are associated with the magnetic encoder.

### CROSS REFERENCE TO RELATED APPLICATIONS

This application is the U.S. national phase application of PCT International Application No. PCT/EP2008/050920, filed Jan. 28, 2008, which claims priority to German Patent Application No. DE102007005220.2, filed Jan. 29, 2007 and German Patent Application No. DE102007057050.5, filed Nov. 27, 2007, the contents of such applications being incorporated by reference herein.

### BACKGROUND OF THE INVENTION

1. Field of the Invention

The invention relates to a sensor arrangement for measurement of a torque acting on a shaft and to the use of the sensor arrangement in motor vehicles.

2. Description of the Related Art

In motor vehicles, it is frequently necessary to measure the torque acting on a shaft. This relates in particular to the steering shaft in the steering system of a motor vehicle, with the steering torque being provided as a measurement variable for a number of motor vehicle control systems. The steering torque is in this case normally measured indirectly, by detection of the deflection of a torsion rod.

Document EP 1 269 133 A1 proposes a position sensor for measurement of the torque of a steering column, which comprises a magnetic multipole encoder ring and a magnetic stator with two ferromagnetic wheels having a plurality of teeth which engage in one another. In this case, the magnetic flux density between the two ferromagnetic wheels is detected with the aid of magnetic field sensor elements, and the position of the encoder with respect to the stator, and from this the torque, are determined from the output signals from the magnetic field sensor elements. It is proposed that a plurality of magnetic field sensor elements be used for accurate and reliable measurement. However, this arrangement distributes the magnetic flux density between a plurality of magnetic field sensor elements, as a result of which a respectively lower value of the magnetic flux density can be detected, thus increasing the susceptibility to disturbances. The measurement of the proposed position sensor is relatively susceptible to external magnetic disturbance fields. Magnetic disturbance fields such as these occur, for example, as a result of the conductors, through which relatively large currents flow, in tram systems or roadway heating systems and, in modern vehicles, they are caused by electrical drives, for example in an electrical steering system or an electrical vehicle drive.

Document DE 102 22 118 A1 describes a torque sensor which operates essentially in the same way as the above sensor but additionally has a magnetic shield around the encoder, the stator and the magnetic field sensor elements. A shield such as this consumes a relatively large amount of material and is therefore costly. Furthermore, a shield such as this increases the dimensions of the torque sensor.

### SUMMARY OF THE INVENTION

In at least one aspect, the invention provides a sensor arrangement for measurement of a torque acting on a shaft, which arrangement is less susceptible to disturbances caused by external magnetic fields.

At least one aspect of the invention is based on the idea of reducing the disturbance susceptibility to external magnetic fields by arranging at least one additional second stator on the shaft section of the first stator. This additional stator likewise has two stator elements, each with projecting fingers.

The sensor arrangement according to at least one aspect of the invention in particular has two magnetic circuits, thus allowing redundant detection of the torque even without a plurality of torque sensors and/or without a plurality of sensor elements, wherein the magnetic field of the two magnetic circuits can be detected and evaluated together or jointly, or separately. This redundancy of the two magnetic circuits results in relatively high reliability and fail-safety of the sensor arrangement.

The magnetic encoder and the stators are each arranged directly or indirectly on the two shaft sections.

The first and the second shaft section are preferably connected to one another by means of a torsion rod, and are coupled to one another directly or indirectly, and can rotate with respect to one another.

The two shaft sections are preferably each in the form of sleeves which are mounted on the shaft or on the torsion element.

The stators, and in particular the respective stator elements, are expediently at least partially formed from soft-magnetic material. In this case, particularly preferably, the magnetic field which is produced by the magnetic encoder passes at least partially through the stator elements of the two stators.

One or both shaft sections is or are preferably mounted directly or indirectly such that it or they can rotate, and the torque acting on the shaft causes the two shaft sections to rotate relative to one another.

It is preferable for the two stators to be arranged and formed on the second shaft section alongside one another, in particular with mirror-image symmetry with respect to their common contact surface.

At least one magnetic field sensor element is preferably respectively directly or indirectly associated with each stator and detects the magnetic flux density in the magnetic circuit comprising at least the two stator elements of a stator and the magnetic encoder, or detects a magnetic variable which is dependent thereon. At least one magnetic field sensor element can in each case particularly preferably deduce the position between the magnetic encoder and the stators and therefore the torque to be measured, and can calculate this, from the output signals from this at least one magnetic field sensor element in each case.

The expression a magnetic field sensor element means a magneto electrical transducer element, preferably a Hall element or a magneto resistive sensor element. A magnetic field sensor element such as this in particular has an integrated, electronic signal processing circuit.

The magnetic encoder is expediently an encoder ring and in particular is formed integrally and such that both stators are associated with it. Alternatively and preferably, the sensor arrangement has two or more magnetic encoders or encoder rings which are arranged alongside one another on the first shaft section. Particularly preferably, the magnetic encoder is magnetized alternately, or is a multipole encoder.

The stator elements are respectively or jointly associated with at least one flux concentrator, which essentially supplies the magnetic field to be detected, in particular in pairs, to the one or more magnetic field sensor elements. In particular, the at least one flux concentrator is formed from soft-magnetic material and is magnetically coupled, in each case via an air gap, to the one or more associated stator elements and to the one or more magnetic field sensor elements. Particularly preferably, each stator has an associated flux concentrator which in particular comprises an inner and an outer concentrator element, with the magnetic field sensor element being arranged in an air gap between these two concentrator elements, and with the inner concentrator element in particular being arranged at least partially between the two stators. The two inner concentrator elements of the two flux concentrators are very particularly preferably integrally connected to one another.

In particular, an external disturbance magnetic field causes a magnetic flux in the sensor arrangement, which magnetic flux is passed through the joint flux concentrators or through both flux concentrators. This magnetic flux is preferably detected with the same orientation by the respective sensor element which is associated with one stator and the other stator, in each case with the mutually inverse orientation, as a result of which the component of this detected disturbance flux can be identified and can be calculated out during the evaluation process. Alternatively and preferably, the sensor arrangement has a common magnetic field sensor element in the area of the two inner concentrator elements, which does not detect the disturbance flux because this disturbance flux bypasses the common magnetic field sensor element via the outer or the common outer concentrator element and essentially does not pass through any of the magnetic circuits, since the magnetic permeability of the two concentrator elements, or of the common outer concentrator element, is considerably greater than the magnetic permeability of one of the magnetic circuits.

One stator element of each stator is expediently associated with the inner concentrator element of a flux concentrator, and the other stator element is associated with the outer concentrator element of a flux concentrator. In this case, the respective stator elements and the concentrator elements associated with them are magnetically coupled to one another via an air gap.

Preferably, in particular additionally, the sensor arrangement has at least one common magnetic field sensor element. This common magnetic field sensor element is in this case particularly preferably arranged essentially in the area of the inner concentrator elements and/or between the inner and outer concentrator elements, and is arranged in the axial direction so close to the stators that the flux concentrators, in particular the outer concentrator elements, project at least partially beyond this common magnetic field sensor element in the axial direction. In consequence, at least one subarea of the common flux concentrator or of the two flux concentrators forms a magnetically permeable means, providing a bypass for external magnetic disturbance fluxes on the common magnetic field sensor element. Thus, in particular, the common magnetic field sensor element is arranged such that it detects a magnetic flux density which is dependent on the common magnetic flux of the two magnetic circuits of the two stators. In this case, flux concentrators which are associated with the respective stators particularly preferably each have an inner and an outer concentrator element. These are very particularly preferably designed such that the outer concentrator elements of the two flux concentrators are magnetically permeably, in particular integrally, connected to one another, and are designed and arranged such that the magnetic reluctance between the outer flux concentrators is considerably less than the magnetic reluctance of in each case one of the two magnetic circuits. In this case, a magnetic circuit such as this in particular comprises two stator elements, a magnetic field sensor element, a flux concentrator, a magnetic encoder and the air gaps between these components. This arrangement means that the magnetic flux which results from an external magnetic disturbance field is essentially not passed through the common magnetic field sensor element but bypasses it via the outer concentrator elements on the magnetic field sensor element, as a result of which the output signal from this common magnetic field sensor element is essentially independent of external disturbance magnetic fields.

Each stator is preferably in each case associated with at least one magnetic field sensor element, from whose output signal the component of an external magnetic disturbance field is measured and/or calculated and is taken into account for correction purposes in the calculation of the torque acting on the shaft.

The at least one output signal from at least one common magnetic field sensor element is preferably used in the calculation of the torque acting on the shaft, in order to increase the accuracy and/or in order to check the plausibility of the measurement signals and/or for redundancy reasons.

The output signals from at least two magnetic field sensor elements are expediently compared with one another, and this comparison result, or in particular a comparison result which has been processed further, is used to assess the serviceability of the sensor arrangement and/or the magnetic field sensor elements of a magnetic circuit. This increases the intrinsic safety of the sensor arrangement.

It is preferable that, with respect to the mechanical design, a stator element of a stator is connected to a stator element of another stator, essentially without magnetic permeability, and, in particular, these two stator elements form one component. Particularly preferably, the two stator elements of a stator correspondingly form one component and/or all the stator elements of all the stators are magnetically connected to one another, essentially without magnetic permeability, and thus form one component. Very particularly preferably, the stator elements are each connected to one another by a plastic mount, in particular preferably being fitted thereto and/or being at least partially surrounded thereby, by injection molding. The fixing of stator elements with respect to one another results in more robustness and better measurement precision.

Expediently, one or more of the magnetic field sensor elements and in particular additionally an electronic signal processing circuit and/or some other electronic, particularly preferably integrated, circuit, are arranged jointly on one chip or one board.

The stator elements preferably each comprise a soft-magnetic ring element, which ring elements have fingers, in particular essentially trapezoidal fingers, which project axially with respect to the shaft, wherein these fingers of the stator elements of a common stator engage in one another without touching. Particularly preferably, each stator has as many fingers as the magnetic encoder has pole pairs.

The invention also relates to the use of the sensor arrangement in motor vehicles, in particular as a torque sensor which is arranged on a driven shaft and/or is integrated in a steering system.

The sensor arrangement according to the invention is preferably intended for use in safety-critical systems and/or in systems which must be of redundant design.

The sensor arrangement according to the invention is intended for use in systems which have at least one shaft whose torque is intended to be detected. In this case, it is envisaged in particular that the sensor arrangement will be arranged on a torsion element which connects two shaft segments to one another. Motor vehicles and systems for automation are particularly preferably proposed as a field of use for the sensor arrangement. Use is particularly preferably envisaged in the steering system of a motor vehicle.

### BRIEF DESCRIPTION OF THE DRAWINGS

The invention is best understood from the following detailed description when read in connection with the accompanying drawings. Included in the drawings is the following figures:

FIG. 1 shows one embodiment according to the prior art,

FIG. 2 shows the side view of this embodiment,

FIG. 3 shows one exemplary sensor arrangement having two stators and two magnetic field sensor elements, which are each associated with the magnetic circuit of a stator, and

FIG. 4 shows an alternative exemplary sensor arrangement as in FIG. 3, having only one magnetic field sensor element, which is jointly associated with the magnetic circuits of both stators.

### DETAILED DESCRIPTION OF THE PREFERRED EMBODIMENTS

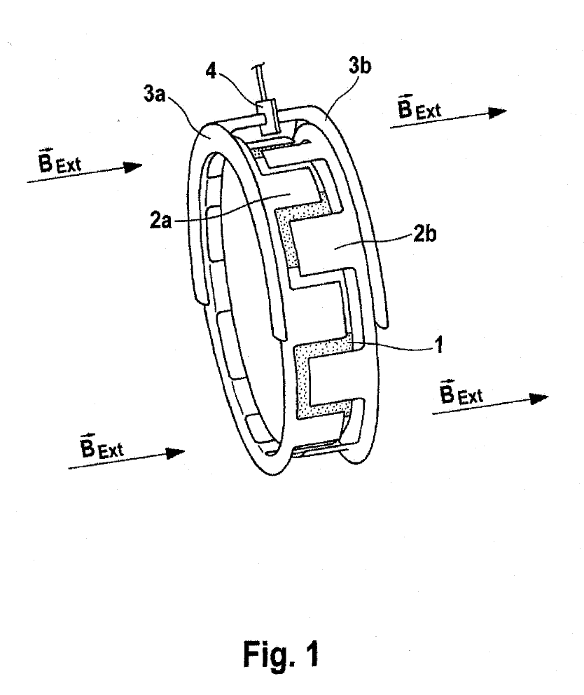

FIG. 1 illustrates a sensor according to the prior art. A magnetic multipole encoder ring 1 produces a magnetic field. A magnetic flux is produced through the stator by relative rotation of the stator elements 2a and 2b relative to an encoder ring 1, as a consequence of twisting of a torsion rod, which is not illustrated, by a torque acting on a shaft. In this case, the encoder or multipole encoder ring 1 as well as stator elements 2a, 2b are each arranged on a different shaft section of a shaft, with these two shaft sections being connected to one another by means of the torsion rod. The lines of force of the magnetic flux run from the multipole encoder ring 1 through the stator element 2a. The stator elements 2a, 2b have a respectively associated concentrator element 3a, 3b of a flux concentrator. The concentrator element 3a concentrates the flux and passes it in a concentrated form through a Hall element 4 in the concentrator element 3b. From there, the magnetic flux is passed through the stator element 2b again to the multipole encoder ring 1. An external, that is to say acting from the outside, disturbance magnetic field \vec{B}_{Ext} produces an additional magnetic flux in the stator, wherein this disturbance magnetic field \vec{B}_{Ext} essentially cannot be distinguished from the magnetic field to be detected, or the magnetic field produced by the multipole encoder ring 1, in the course of the measurement. In this case, its lines of force pass through the flux concentrators 3a and 3b and, partially, through the stator elements 2a and 2b.

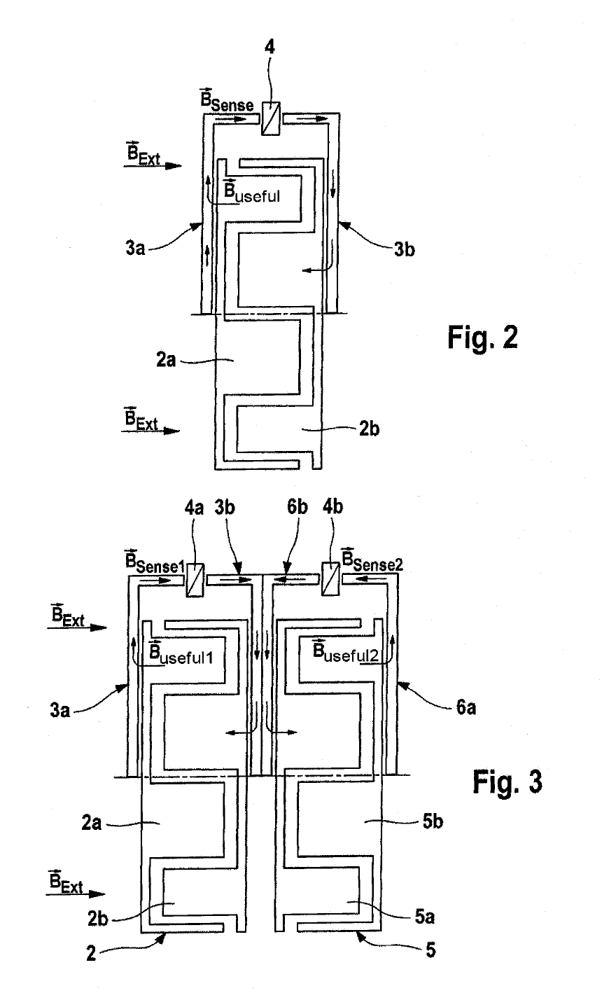

FIG. 2 shows the side view of the sensor shown in FIG. 1. The multipole encoder ring 1 produces a magnetic flux in the stator, which is passed via the stator element 2a and the concentrator element 3a to the Hall element 4, and is passed back again via the concentrator element 3b and the stator element 2b. At the illustrated position, this magnetic flux has a magnetic flux density \vec{B}_{useful}. In addition, the external disturbance magnetic field \vec{B}_{Ext} produces a magnetic flux in the stator. The Hall element 4 therefore detects the magnetic flux density \vec{B}_{Sens} which comprises the flux density \vec{B}_{useful} of the magnetic real flux produced by the multipole encoder ring 1 and a component (factor x) of the flux density \vec{B}_{Ext} of the external disturbance magnetic field. The injected component of \vec{B}_{Ext} is included, by way of example, to a major extent in the measurement of the Hall element 4, and cannot be taken into account, for correction purposes, in the subsequent evaluation. The magnetic flux density measured by the Hall element 4 is therefore as follows:

\vec{B}_{Sens}=\vec{B}_{useful}+x*\vec{B}_{Ext}.

FIG. 3 shows the exemplary embodiment of a further-developed sensor arrangement, relating to the sensor arrangement shown in FIGS. 1 and 2. This embodiment is able to detect the stray flux from the external disturbance magnetic field \vec{B}_{Ext}, as a result of which the disturbance components which result from this in the measurement signal can be compensated for in the course of subsequent signal processing, or can be taken into account, for correction purposes, in the subsequent evaluation. This embodiment has an additional stator 5, with two stator element 5a, 5b and concentrator elements 6a and 6b associated with them, and an additional Hall element 4b. The first stator 2 and the second stator 5, the respectively associated concentrator elements 3a, 3b, 6a, 6b of the two flux concentrators, each comprising an outer concentrator element 3a, 6a and an inner concentrator element 3b, 6b, as well as the Hall elements 4a, 4b are designed and arranged with mirror-image symmetry with respect to a central boundary surface between the stators 2, 5. The multipole encoder ring, which is not shown but is jointly associated with both stators 2, 5, produces a respective magnetic flux \vec{B}_{useful1}, \vec{B}_{useful2}, in the stators, which flux passes through the two Hall elements 4a and 4b in the exemplary sensor arrangement, in the same direction but with opposite orientation. The magnitudes of the magnetic flux densities of the useful fluxes \vec{B}_{useful1} and \vec{B}_{useful2} are in this case the same, but they have a correspondingly inverse orientation with respect to one another. The Hall elements 4a and 4b detect the following magnetic flux densities:

\vec{B}_{Sens1}=\vec{B}_{useful1}+x*\vec{B}_{Ext}

\vec{B}_{Sens2}=−\vec{B}_{useful2}+x*\vec{B}_{Ext}

The external disturbance magnetic field \vec{B}_{Ext} can be calculated and eliminated, with respect to its magnetic flux density, which is scattered or injected in and is relevant for the sensor arrangement, by evaluation and if appropriate averaging of the magnetic field sensor element output signals, by means of the magnetic flux densities \vec{B}_{useful1} and \vec{B}_{useful2} which have mutually inverse orientations, and because the design of the sensor arrangement in the example is symmetrical. This results in the following output signals, wherein U_{useful} corresponds to the total signal from the magnetic field sensor elements, which is obtained from the difference between the output signals from the Hall element 4a, _{Hall 1} and the Hall element 4b, U_{Hall 2}:

U_{Hall 1}=f(\vec{B}_{Sens1}+x*\vec{B}_{Ext})

U_{Hall 2}=f(\vec{B}_{Sens2}+x*\vec{B}_{Ext})

U_{useful}=U_{Hall 1}−U_{Hall 2}

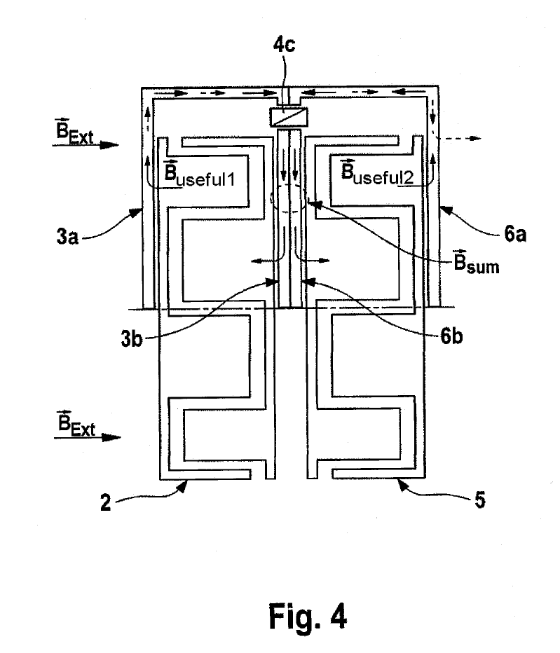

FIG. 4 shows an alternative exemplary embodiment of the sensor arrangement, which likewise shows a further development of the sensor arrangement illustrated in FIGS. 1 and 2. In comparison to FIG. 3, in this case the flux densities of the individual fluxes \vec{B}_{Sens1}, \vec{B}_{Sens2} are not detected, but a sum flux or total flux \vec{B}_{Sum}, which results from the sum of the two individual fluxes \vec{B}_{useful1}, \vec{B}_{useful 2}, (useful fluxes of the two stators 2, 5) which have the same orientation in this area. This is detected and measured by means of an individual magnetic field sensor element 4c which, according to the example, is a Hall element and is arranged in the area of the boundary surface between the two stators and in a common air gap between the flux concentrators, which are associated with the stators 2, 5 and have concentrator elements 3a, 3b, 6a and 6b. By way of example, the magnetic field sensor element 4c is arranged centrally between the two stators, and the magnetic fluxes

\vec{B}_{Sum}=\vec{B}_{useful1}+\vec{B}_{useful2}

which are concentrated by the flux concentrators, pass through them. The magnetic flux, which enters the sensor arrangement from an external disturbance magnetic field \vec{B}_{Ext} and whose profile is indicated in FIG. 4 by dashed arrows, is carried externally via the outer concentrator elements 3a, 6a of the two stators 2, 5 such that this does not make up any significant component of the magnetic flux density \vec{B}_{Sum}, detected by the magnetic field sensor element 4c. The flux concentrators and the outer concentrator elements 3a, 6a are designed and arranged such that essentially no disturbance flux is passed via the inner concentrator elements 3b, 6b and thus through the magnetic field sensor element 4c. There is therefore no need to provide additional suppression for the sensor arrangement output signals, by means of signal evaluation.

In one exemplary embodiment, which is not illustrated, all the magnetic field sensor elements from FIGS. 3 and 4 are present, and both compensation principles can be used in order to reduce the disturbance effect of the disturbance magnetic field even further.

According to the example, all the magnetic field sensor elements are arranged on a central sensor board, which is not illustrated, and are connected to it. According to the example, the sensor board optionally has an electrical power source or a supply line to an electrical power source. In addition, the sensor board has an electronic signal processing circuit, which processes the output signals from the magnetic field sensor elements, and which is likewise connected to the power source.

In a more advanced exemplary embodiment, which is not illustrated, the sensor board has additional means for connection of additional magnetic field sensor elements and/or sensors. These do not necessarily need to be accommodated in the same housing as the sensor arrangement. By way of example, this is a separate steering angle sensor, which can be supplied with power from the sensor arrangement. The output signals from the separate sensors or sensor elements can optionally be combined with the sensor signals from the sensor arrangement, and/or can be processed, and can be optionally transmitted to an external evaluation unit or an external electronic control unit. In an additional exemplary embodiment, the sensor board of the sensor arrangement has an electronic control unit which controls a steering system.

1.-10. (canceled)

11. A sensor arrangement for measurement of a torque acting on a shaft, wherein the shaft has a first shaft section and a second shaft section and these two shaft sections can rotate with respect to one another, having at least one magnetic encoder which is arranged on the first shaft section, and having a stator which is arranged on the second shaft section, wherein the stator has two stator elements which each have projecting fingers, and wherein at least one additional, second stator, likewise having two stator elements which each have projecting fingers, is arranged on the second shaft section, and these stators are associated with the magnetic encoder.

12. The sensor arrangement as claimed in claim 11, wherein at least one magnetic field sensor element is respectively directly or indirectly associated with each stator and detects the magnetic flux density in the magnetic circuit comprising at least the two stator elements of a stator and the magnetic encoder.

13. The sensor arrangement as claimed in claim 11, wherein the stator elements are respectively or jointly associated with at least one flux concentrator, which supplies the magnetic field to be detected to the magnetic field sensor element or elements.

14. The sensor arrangement as claimed in claim 11, wherein the sensor arrangement has at least one common magnetic field sensor element which detects a magnetic flux density which is dependent on the common magnetic flux (\vec{B}ₛᵤₘ) of the two magnetic circuits of the two stators, and which is arranged such that the flux concentrators project at least partially in the axial direction beyond this common magnetic field sensor element.

15. The sensor arrangement as claimed in claim 12, wherein a component of an external magnetic disturbance field is measured and/or calculated from the output signals from the at least two magnetic field sensor elements which are respectively associated with a stator, and this is taken into account, for correction purposes, in the calculation of the torque acting on the shaft.

16. The sensor arrangement as claimed in claim 12, wherein the at least one output signal from at least one common magnetic field sensor element is used in the calculation of the torque acting on the shaft, in order to increase the accuracy and/or in order to check the plausibility of the measurement signals and/or for redundancy reasons.

17. The sensor arrangement as claimed in claim 12, wherein the output signals from at least two magnetic field sensor elements are compared with one another, and this comparison result is used to assess the serviceability of the sensor arrangement and/or the magnetic field sensor elements of a magnetic circuit.

18. The sensor arrangement as claimed in claim 12, wherein at least one stator element of a stator is connected to at least one stator element of another stator, essentially without magnetic permeability and these two stator elements form one component.

19. The sensor arrangement as claimed in claim 11, wherein the stator elements each comprise a soft-magnetic ring element, which ring elements have fingers which project axially with respect to the shaft, wherein the fingers of the stator elements of a common stator engage in one another without touching.

20. The use of the sensor arrangement as claimed in claim 11 in a motor vehicle steering system.
